(19) United States
(12) Patent Application Publication
(10) Pub. No.: US 2025/0114913 A1
(43) Pub. Date: Apr. 10, 2025

(54) PLIERS TOOL WITH GRIPPING COMPONENTS

(71) Applicant: Naiaf Jaber, Burlington, WI (US)

(72) Inventor: Naiaf Jaber, Burlington, WI (US)

(21) Appl. No.: 18/378,004

(22) Filed: Oct. 9, 2023

(51) Int. Cl. B25B 7/12; B25B 7/02

(52) U.S. Cl. CPC B25B 7/123; B25B 7/02

(57) ABSTRACT

A pliers tool for gripping fasteners and other objects includes a pair of jaws and a pair of handles which are operable to open and close the jaws. A pair of grip members are mounted to the jaws and are positioned to engage a fastener when the jaws are closed around the fastener. Each grip member has a base and a plurality of nodules which are spaced along the base.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pliers tools and more particularly pertains to a new pliers tool for gripping fasteners and other objects.

### (2) Description of Related Art including information disclosed under 37 CFR 1.97 and 1.98

The prior art describes myriad pliers tools having various gripping means for gripping a fastener between a pair of jaws of the pliers tool. However, the prior art fails to disclose such a pliers tool which has grip members mounted to the jaws the priors tool having a base and a plurality of spaced nodules. The grip members provide an alternative gripping surface for gripping fasteners and other objects than those provided by the prior art.

### BRIEF SUMMARY OF THE INVENTION

An embodiment of the disclosure meets the needs presented above by generally comprising a pair of jaws which are pivotally interconnected at first ends thereof. Each jaw of the pair of jaws has a second end opposite the first end. Each jaw of the pair of jaws has an engagement surface which faces another jaw of the pair of jaws when the pair of jaws is positioned in a closed position. Each one of a pair of grip members is mounted to an engagement surface of an associated jaw of the pair of jaws. A length of each grip member of the pair of grip members extends in a direction between the first end and the second end of the associated jaw and comprises a base and a plurality of nodules. The base is mounted on and conforms to the engagement surface of the associated jaw, and the plurality of nodules is mounted on the base opposite the associated jaw. A pair of handles is operably coupled to the pair of jaws, and the jaws are movable toward each other to urge the pair of jaws toward each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a pliers tool according to an embodiment of the disclosure.

FIG. 2 is a bottom perspective view of an embodiment of the disclosure.

FIG. 3 is a side view of an embodiment of the disclosure.

FIG. 4 is a front view of an embodiment of the disclosure.

FIG. 5 is a cross-section view of an embodiment of the disclosure taken from Arrows 5-5 in FIG. 4.

FIG. 6 is a side view of an embodiment of the disclosure.

FIG. 7 is a side view of an embodiment of the disclosure.

### DETAILED DESCRIPTION OF THE INVENTION

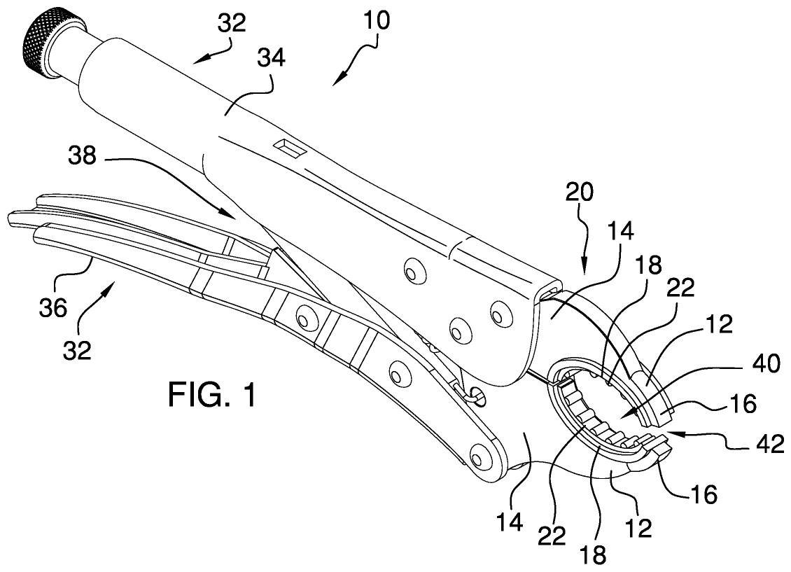

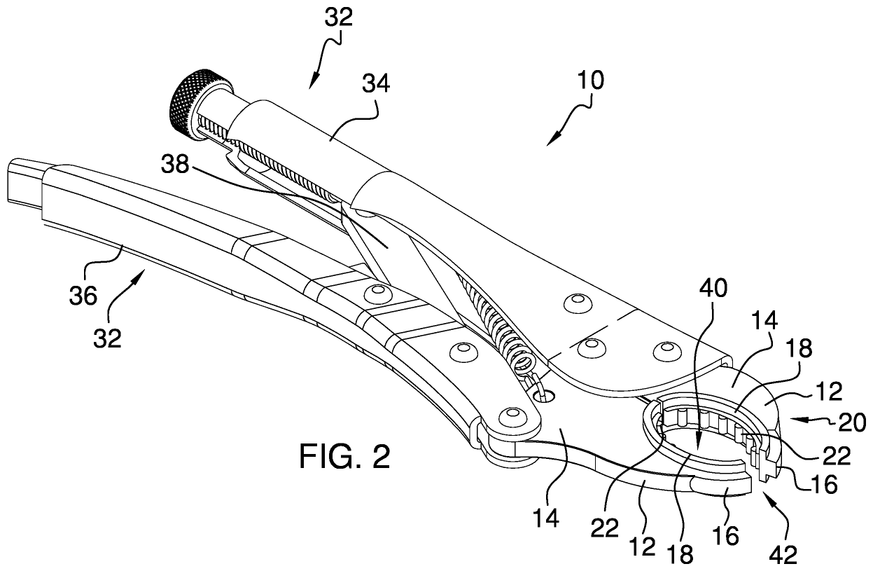

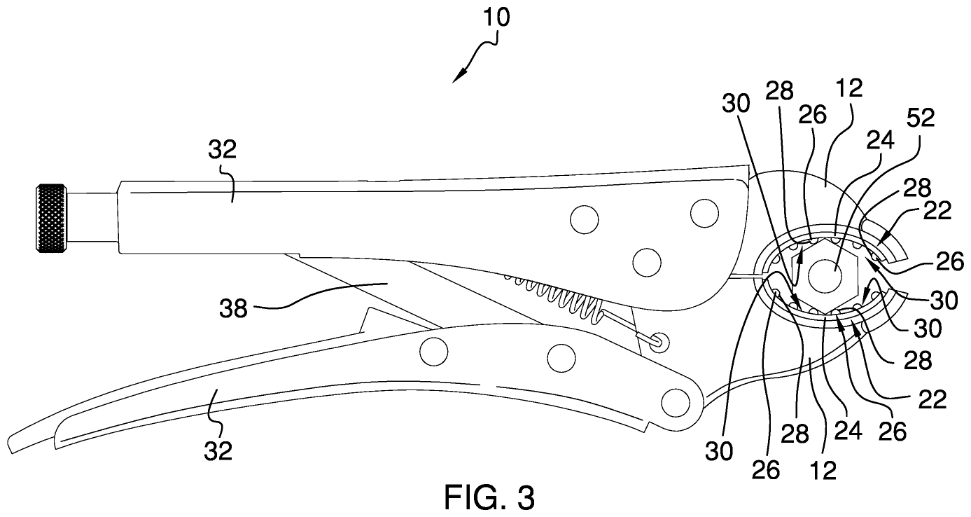

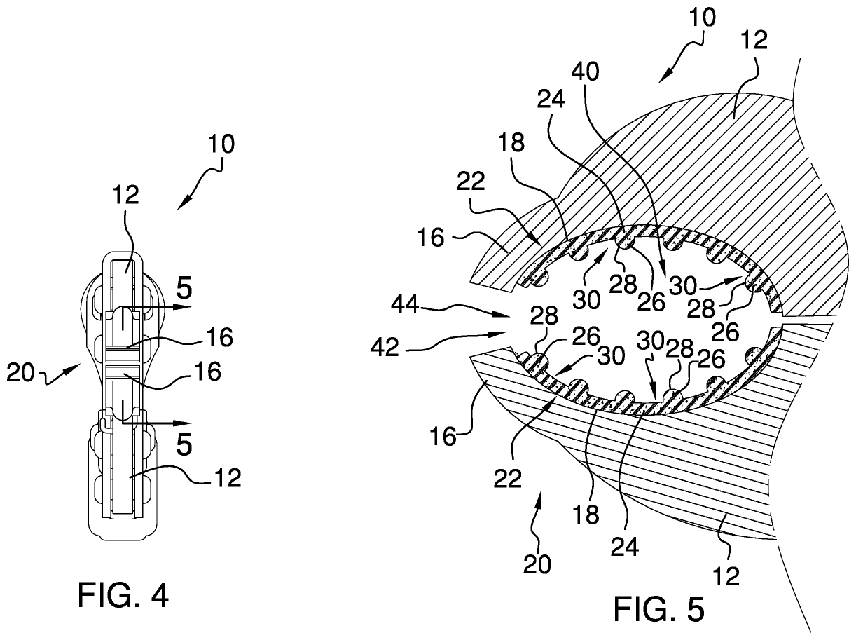

With reference now to the drawings, and in particular to FIGS. 1 through 7 thereof, a new pliers tool embodying the principles and concepts of an embodiment of the disclosure and generally designated by the reference numeral 10 will be described.

As best illustrated in FIGS. 1 through 7, the pliers tool 10 generally comprises a pair of jaws 12 which are pivotally interconnected at first ends 14 thereof. Each jaw 12 of the pair of jaws 12 has a second end 16 opposite the first end 14 and an engagement surface 18 which faces another jaw 12 of the pair of jaws 12 when the pair of jaws 12 is positioned in a closed position 20.

Each one of a pair of grip members 22 is mounted to an engagement surface 18 of an associated jaw 12 of the pair of jaws 12. A length of each grip member 22 of the pair of grip members 22 extends in a direction between the first end 14 and the second end 16 of the associated jaw 12. Each grip member 22 comprises a base 24 and a plurality of nodules 26. The base 24 is mounted on and conforming to the engagement surface 18 of the associated jaw 12, and the plurality of nodules 26 is mounted on the base 24 opposite the associated jaw 12. The nodules 26 are evenly spaced along the length of the grip member 22. A spacing 30 between adjacent nodules 26 of the plurality of nodules 26 is equal to a width of each nodule 26 of the pair of nodules 26. Each nodule 26 of the pair of nodules 26 has a convexly arcuate surface 28 facing away from the base 24. Each grip member 22 of the pair of grip members 22 comprises a resiliently compressible material. The resiliently compressible material comprises rubber but may comprise silicone, another polymer, or the like.

A pair of handles 32 is operably coupled to the pair of jaws 12. Each handle 32 of the pair of handles 32 is coupled to an associated jaw 12 of the pair of jaws 12. The pair of handles 32 includes a fixed handle 34 coupled to one jaw 12 of the pair of jaws 12 and a movable handle 36 pivotally coupled to another jaw 12 of the pair of jaws 12. The movable handle 36 is movable toward the fixed handle 34 to close the pair of jaws 12 and away from the fixed handle 34 to open the pair of jaws 12. An over-center lock 38 is coupled to the pair of handles 32 such that the pair of handles 32 are securable in a selected position to secure the pair of jaws 12 in the closed position 20.

Referring to FIGS. 1 through 5, the engagement surfaces 18 of the pair of jaws 12 in a first embodiment form a space 40 between the pair of jaws 12 when the pair of jaws 12 is positioned in the closed position 20. The space 40 has an elliptical shape 44, and the second ends 16 of the pair of jaws 12 are spaced from each other to define an opening 42 to the space 40 when the pair of jaws 12 is positioned in the closed position 20.

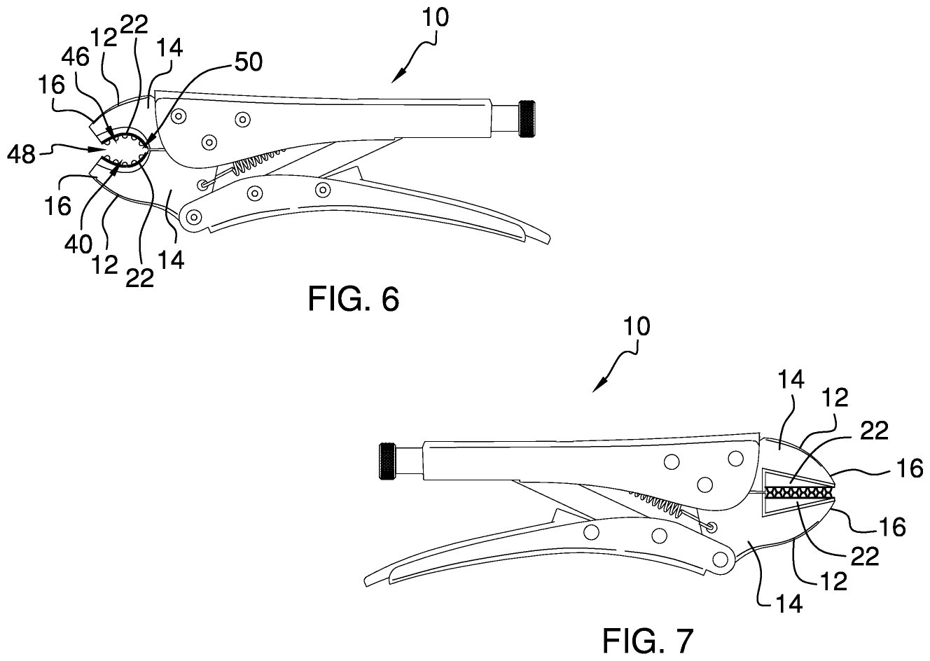

Referring to FIG. 6, the engagement surfaces 18 of the pair of jaws 12 in a second embodiment form a space 40 between the pair of jaws 12 when the pair of jaws 12 is positioned in the closed position 20. The space 40 has an ovate shape 46 wherein a narrow end 48 of the ovate shape 46 is positioned closer to the second ends 16 of the pair of jaws 12 than a broad end 50 of the ovate shape 46, and the second ends 16 of the pair of jaws 12 are spaced from each other to define an opening 42 to the space 40 when the pair of jaws 12 is positioned in the closed position 20.

Referring to FIG. 7, the engagement surface 18 of each jaw 12 of the pair of jaws 12 in a third embodiment is planar. The engagement surfaces 18 of the pair of jaws 12 of the third embodiment lie adjacent to and parallel to each other when the pair of jaws 12 is positioned in the closed position 20.

In use, the handles 32 are operated to open and close the jaws 12. The grip members 22 facilitate tightly gripping a fastener 52 or other item to allow the pliers tool 10 to move the fastener 52 or other item as desired.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pliers tool comprising:
a pair of jaws being pivotally interconnected at first ends of the pair of jaws, each jaw of the pair of jaws has a second end opposite the first end, each jaw of the pair of jaws has an engagement surface which faces another jaw of the pair of jaws when the pair of jaws is positioned in a closed position;
a pair of grip members, each grip member being mounted to an engagement surface of an associated jaw of the pair of jaws, a length of each grip member of the pair of grip members extending in a direction between the first end and the second end of the associated jaw, each grip member comprising a base and a plurality of nodules, the base being mounted on and conforming to the engagement surface of the associated jaw, the plurality of nodules being mounted on the base opposite the associated jaw; and
a pair of handles being operably coupled to the pair of jaws, the pair of handles being movable toward each other to urge the pair of jaws toward each other.

2. The tool of claim 1, wherein the nodules of the plurality of nodules are evenly spaced along the length of the grip member.

3. The tool of claim 2, wherein a spacing between adjacent nodules of the plurality of nodules is equal to a width of each nodule of the pair of nodules.

4. The tool of claim 1, wherein each nodule of the pair of nodules has a convexly arcuate surface facing away from the base.

5. The tool of claim 1, wherein each grip member of the pair of grip members comprises a resiliently compressible material.

6. The tool of claim 5, wherein the resiliently compressible material comprises rubber.

7. The tool of claim 1, wherein each handle of the pair of handles is coupled to an associated jaw of the pair of jaws, the pair of handles including a fixed handle coupled to one jaw of the pair of jaws and a movable handle pivotally coupled to another jaw of the pair of jaws, the movable handle being movable toward the fixed handle to close the pair of jaws and away from the fixed handle to open the pair of jaws.

8. The tool of claim 1, further comprising an over-center lock being coupled to the pair of handles such that the pair of handles are securable in a selected position to secure the pair of jaws in the closed position.

9. The tool of claim 1, wherein the engagement surfaces of the pair of jaws form a space between the pair of jaws when the pair of jaws is positioned in the closed position.

10. The tool of claim 9, wherein the space has an elliptical shape.

11. The tool of claim 9, wherein the second ends of the pair of jaws are spaced from each other to define an opening to the space when the pair of jaws is positioned in the closed position.

12. The tool of claim 9, wherein the space has an ovate shape wherein a narrow end of the ovate shape is positioned closer to the second ends of the pair of jaws than a broad end of the ovate shape.

13. The tool of claim 1, wherein the engagement surface of each jaw of the pair of jaws is planar, the engagement surfaces of the pair of jaws lying adjacent to and parallel to each other when the pair of jaws is positioned in the closed position.

14. A pliers tool comprising:
a pair of jaws being pivotally interconnected at first ends of the pair of jaws, each jaw of the pair of jaws has a second end opposite the first end, each jaw of the pair of jaws has an engagement surface which faces another jaw of the pair of jaws when the pair of jaws is positioned in a closed position;
a pair of grip members, each grip member being mounted to an engagement surface of an associated jaw of the pair of jaws, a length of each grip member of the pair of grip members extending in a direction between the first end and the second end of the associated jaw, each grip member comprising a base and a plurality of nodules, the base being mounted on and conforming to the engagement surface of the associated jaw, the plurality of nodules being mounted on the base opposite the associated jaw, the plurality of nodules being evenly spaced along the length of the grip member, a spacing between adjacent nodules of the plurality of nodules being equal to a width of each nodule of the pair of nodules, each nodule of the pair of nodules has a convexly arcuate surface facing away from the base, each grip member of the pair of grip members comprising a resiliently compressible material, the resiliently compressible material comprising rubber;
a pair of handles being operably coupled to the pair of jaws, each handle of the pair of handles being coupled to an associated jaw of the pair of jaws, the pair of handles including a fixed handle coupled to one jaw of the pair of jaws and a movable handle pivotally coupled to another jaw of the pair of jaws, the movable handle being movable toward the fixed handle to close the pair of jaws and away from the fixed handle to open the pair of jaws; and
an over-center lock being coupled to the pair of handles such that the pair of handles are securable in a selected position to secure the pair of jaws in the closed position.

15. The tool of claim 1, wherein the engagement surfaces of the pair of jaws form a space between the pair of jaws when the pair of jaws is positioned in the closed position, the space has an elliptical shape, the second ends of the pair of jaws being spaced from each other to define an opening to the space when the pair of jaws is positioned in the closed position.

16. The tool of claim 1, wherein the engagement surfaces of the pair of jaws form a space between the pair of jaws when the pair of jaws is positioned in the closed position, the space has an ovate shape wherein a narrow end of the ovate shape is positioned closer to the second ends of the pair of jaws than a broad end of the ovate shape, the second ends of the pair of jaws being spaced from each other to define an opening to the space when the pair of jaws is positioned in the closed position.

17. The tool of claim 1, wherein the engagement surface of each jaw of the pair of jaws is planar, the engagement surfaces of the pair of jaws lying adjacent to and parallel to each other when the pair of jaws is positioned in the closed position.
